(19) United States
(12) Patent Application Publication
(10) Pub. No.: US 2024/0082961 A1
(43) Pub. Date: Mar. 14, 2024

(54) Device For Monitoring The State of Optical Elements of A Device For Laser Material Processing

(71) Applicant: II-VI Delaware, Inc., Wilmington, DE (US)

(72) Inventors: Daniel Labahn, Wilmington, DE (US); Danny Chan, Wilmington, DE (US); Patrick Kuhl, Wilmington, DE (US); Romon Chakrabarti, Wilmington, DE (US); Andreas Ziemann, Wilmington, DE (US); Hannes Noack, Wilmington, DE (US)

(21) Appl. No.: 18/368,414

(22) Filed: Sep. 14, 2023

(30) Foreign Application Priority Data
Sep. 29, 2022 (DE) 10 2022 125 123.3

(51) Int. Cl. B23K 26/70; B23K 26/06

(52) U.S. Cl. CPC B23K 26/707; B23K 26/0643; B23K 26/0648

(57) ABSTRACT

The disclosure relates to a system and a method for monitoring the state of optical elements of a device for laser material processing. According to the present disclosure a detailed monitoring of the state of optical elements of a device for laser material processing takes place by monitoring properties of laser radiation in the direction of an optical fiber or laser radiation entering a laser processing head connected to the laser source and these measurements, which can be performed during the processing process. The device according to the present disclosure has optical sensors for measuring the intensity and respective current laser power.

### CROSS-REFERENCE TO RELATED APPLICATIONS

The present disclosure claims priority to German patent application no. DE 10 2022 125 123.3 filed on Sep. 9, 2022. The afore mentioned application is incorporated herein by reference.

### FIELD OF DISCLOSURE

The disclosure relates to a method and a device for monitoring the condition of optical elements of a laser material processing device.

### BACKGROUND OF THE DISCLOSURE

Various devices and methods are known in the state of the art for monitoring the quality of the laser beam, with the results then being used to draw conclusions about the quality of the optical elements. One disadvantage of the devices and methods known from the state of the art is that they do not aim at the determination or monitoring of the optical elements.

Further limitations and disadvantages of conventional and traditional approaches will become apparent to one of skill in the art, through comparison of such systems with some aspects of the present disclosure as set forth in the remainder of the present application with reference to the drawings.

### SUMMARY OF THE DISCLOSURE

The disclosure relates to a method and a device for monitoring the condition of optical elements of a laser material processing device, that overcomes disadvantages found in the prior art.

These and other advantages, aspects and novel features of the present disclosure, as well as details of an illustrated embodiment thereof, will be more fully understood from the following description and drawings.

### BRIEF DESCRIPTION OF THE FIGURES

The disclosure is illustrated in more detail below with reference to figures. It will be obvious to those skilled in the art that these are only possible embodiments, without limiting the disclosure to the embodiments shown. It shows:

FIG. 1 shows the arrangement of optical elements in one embodiment according to the present disclosure.

FIG. 2 shows an embodiment with a filter in front of the sensor.

FIG. 3 shows an embodiment with an aperture in front of the second lens.

FIG. 4 shows an embodiment with additional optical elements.

### DETAILED DESCRIPTION OF THE DISCLOSURE

Lasers with high power are used for material processing. The laser beam emerging from a light source for lasers, such as an optical fiber cable, is collimated and subsequently focused in a laser head attached to its end by means of laser optics with corresponding lenses.

During material processing with a high-power laser, the optical elements of a corresponding device, for example a so-called laser head, are subject to extreme loads. For this reason, it is not only necessary to monitor the properties of the laser beam, but also the condition of the optical elements in such a device, which are involved in beam shaping.

The present disclosure provides a device and a method for monitoring the state of optical elements of an apparatus for laser material processing. In contrast to devices and methods known in the prior art, according to the present disclosure, monitoring of the optical elements takes place in the direction of the optical fiber connected to the laser source—i.e. against the beam direction of the high-power laser beam.

The example device according to the present disclosure has optical sensors for measuring the intensity of light with respect to scattered light and the intensity of the high-power laser beam, as well as for determining the spectral composition of the light. Thus, the temporal resolution of unexpected changes in light intensity as well as the change in a sensor signal is provided.

Furthermore, spatial resolution is enabled with respect to the position of the laser beam in terms of lateral deviations in x- and y-direction, the energy distribution and its center, and the measurement of scattered light.

By determining the aforementioned parameters, it is possible to detect the contamination of optical elements. In addition, it is possible to compensate for contamination of optical elements by adjusting process parameters. This use is not only advantageous in the running process, but also offers the possibility to better plan necessary maintenance and thus prevent an interruption of running processes. Overall, undesirable downtimes of laser material processing equipment can be avoided with a significantly higher degree of probability.

The device comprises a tunable lens or a group of lenses comprising at least one tunable lens in which the lens properties can be adjusted or a linear drive for changing the position of the lens or lens group in the beam path. The respective lenses or lens groups can be moved in the beam path by displacement member comprising drives connected to them. This also includes a movement of the lenses or lens groups relative to each other.

According to an example embodiment of the disclosure, the sensor is a camera, a Shack-Hartmann wavefront sensor, a polarization camera, a hyperspectral camera, or a radiation-sensitive sensor and a matrix beam splitter.

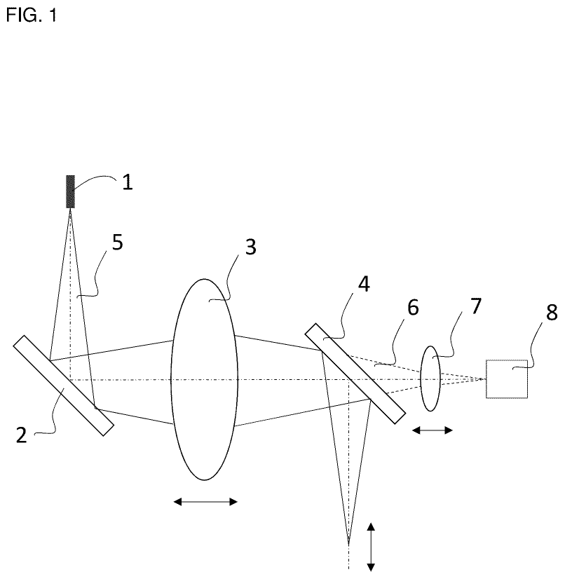

FIG. 1 shows the arrangement of optical elements in a first embodiment of a device according to the present disclosure. A high-power laser beam 5 exits the optical fiber 1 connected to the laser beam source (not shown) and is reflected by the first mirror 2. The optical fiber 1 may be an optical fiber cable and the first mirror 2 may be a deformable or tiltable mirror.

The high-power laser beam 5 is focused by the first lens 3. A dichromatic mirror 4 is arranged between the first lens 3 and the second lens 7, with which a part 6 of the high-power laser beam 5 is coupled out. The coupled-out part 6 of the laser beam is imaged through the second lens 7 onto the sensor 8 arranged behind it. The part of the high-power laser beam reflected by the dichromatic mirror 4 is used for laser material processing.

The second lens 7 is movably arranged so that it can compensate for movements of the first lens. The second lens 7 is movable asynchronously to the first lens 3 to focus on another beam position or to measure the characteristic of the laser beam.

The sensor 8 and the first lens 3 are arranged in such a way that they can be moved asynchronously to each other. The sensor 8 measures the characteristics of a laser beam described above. It is also provided in one embodiment of the disclosure that the sensor 8 is formed from a matrix beam splitter in combination with a camera system.

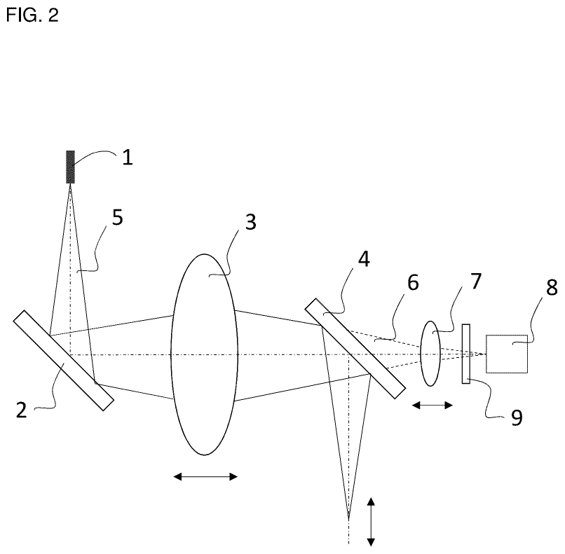

FIG. 2 shows the arrangement of optical elements in an embodiment in which a filter 9 is arranged between second lens (lens group) 7 and sensor 8. Alternatively, the filter can also be arranged between mirror 4 and lens 7. According to the disclosure, it is provided that at least one filter is arranged in the beam path of the outcoupled beam 6. For example, absorption, reflection or polarization filters are provided as filters 9.

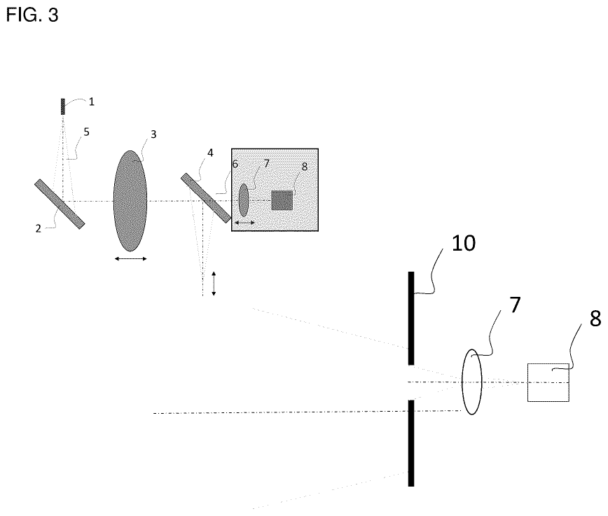

FIG. 3 shows an embodiment in which an aperture 10 is arranged in front of the second lens 7. It is provided in this embodiment that the hole in the aperture 10 is offset with respect to the beam axis. This causes the center of gravity of the beam to shift on the detector 8 when the beam is shifted in the z-direction. This embodiment makes it possible to measure the focus shift in a fixed setup.

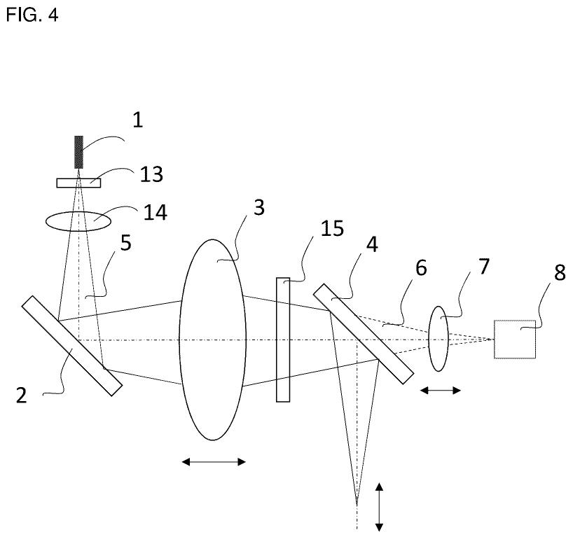

FIG. 4 shows, by way of example, the arrangement of further optical elements in an embodiment in which a protective glass 13 is arranged between the optical fiber 1 and the first mirror 2 to protect the optics against contamination. Furthermore, a third lens or lens group 14 may be arranged in front of the first mirror 2. The beam former 15 behind the first lens 3 may also be arranged elsewhere in the beam path. Beam shapers can influence the focus on the workpiece and thus affect the cut quality, cut speed or cut shape. Assuming a soldering or welding process, the quality of the seam can be positively influenced.

The present disclosure provides a system for monitoring the condition of optical elements of a laser material processing device, comprising
an entrance opening for the laser radiation;
a first deflection mirror arranged in the direction of the beam path behind it for reflecting the laser radiation;
a first lens or lens group arranged behind it in the direction of the beam path;
a dichromatic mirror arranged behind it in the direction of the beam path for coupling out part of the laser radiation;
a second lens disposed there behind in the direction of the outcoupled portion of the optical path; and
a sensor arranged behind it in the direction of the decoupled part of the beam path, on which the decoupled part of the laser radiation impinges.

According to the disclosure, it is further provided that the entry port for laser radiation is a laser light cable connected to a laser source.

It is further provided that the first lens or lens group focuses the laser radiation.

In another embodiment, the second lens or lens group focuses the coupled-out portion of the laser radiation onto the sensor.

Another aspect of the disclosure relates to the first and/or the second lens or lens group, wherein the lens is a so-called tunable lens or the lens group comprises at least one tunable lens comprising liquid lenses, liquid crystalline lenses and lenses made of elastomers whose optical properties are changeable by external excitation such as mechanical or hydrostatic deformation.

The system according to the disclosure further comprises a first lens or lens group connected to a first displacement member and a second lens or lens group connected to a second displacement member for displacing the respective lens or lens group on the beam axis.

According to the disclosure, it is also provided that the sensor is connected to a third displacement device for its displacement along the beam axis.

Another embodiment relates to a system in which an optical filter is arranged between the dichromatic mirror and the sensor.

Another aspect of the disclosure relates to an embodiment in which an aperture is disposed between the dichromatic mirror and the second lens.

Furthermore, a hole of the aperture can be arranged offset to the beam axis of the laser radiation.

In a further embodiment of the disclosure, a protective glass is arranged behind the tip of the optical fiber in the direction of the beam path of the laser radiation, and a third lens or lens group is arranged behind it. The third lens may also be a so-called tunable lens or the lens group has at least one tunable lens.

Furthermore, a beam shaping element can additionally be arranged in the beam path.

For the first mirror, it is also envisaged that it can be a tip-tilt mirror or a deformable mirror.

Another aspect of the present disclosure relates to a method for monitoring the condition of optical elements of a laser material processing device, wherein a sensor receives an outcoupled portion of a high power laser beam in the direction of the beam source, the outcoupled portion of the high power laser beam or laser radiation being outcoupled by a dichromatic mirror.

The method may further comprise the step of forming the high power laser beam or laser radiation through a first lens in front of the dichromatic mirror, wherein the first lens is a so-called tunable lens or the lens group comprises at least one tunable lens.

In the method, the high-power laser beam or radiation may be shaped by a second lens between the dichromatic mirror and the sensor, the second lens being a so-called tunable lens or the lens group comprising at least one tunable lens.

Furthermore, in one embodiment of the method according to the present disclosure, the high-power laser beam or laser radiation can be deflected in the direction of the first lens or lens group by a deflection mirror in front of the first lens or lens group.

The high-power laser beam or laser radiation can pass through a filter in front of the sensor.

Another aspect of the method according to the disclosure relates to the high power laser beam or laser radiation passing through an aperture offset from the beam axis in front of the second lens or lens group.

Ultimately, in the method, the high-power laser beam or laser radiation may also pass between an exit aperture of the high-power laser beam and the deflection mirror through a cover aperture and a third lens.

The present disclosure also relates to the use of a system, as previously described, for monitoring the condition of optical elements of a laser material processing device.

For use, it is provided that at least one property selected from the group comprising the laser beam position in x, y direction, the laser beam diameter, the energy distribution in the laser beam, the center of the laser beam and the wave front of the laser beam is determined.

Other aspects, features and advantages of the present disclosure will readily be apparent from the following detailed description, in which simple preferred embodiments and implementations are illustrated. Additional purposes and advantages of the disclosure are set forth in part in the following description and will become apparent in part from the description or may be inferred from the embodiment of the disclosure.

The foregoing description of the preferred embodiment of the disclosure has been given for the purpose of illustration and description. It is not intended to be exhaustive or to limit the disclosure precisely to the disclosed form. The present disclosure may also be realized in other and different embodiments, and its various details may be modified in various obvious aspects, without departing from the teachings and scope of the present disclosure. Accordingly, the drawings and descriptions are to be considered illustrative and not limiting. Modifications and variations are possible in view of the above teachings or may be obtained from practice of the disclosure. The embodiment has been chosen and described to explain the principles of the disclosure and its practical application to enable those skilled in the art to use the disclosure in various embodiments suitable for the particular use intended. It is intended that the scope of the disclosure be defined by the appended claims and their equivalents. The entirety of each of the foregoing documents is incorporated herein by reference.

What is claimed is:

1. A system for monitoring the state of optical elements of a laser material processing device, comprising
an entrance opening for the laser radiation;
a first deflection mirror arranged in the direction of the beam path of the entered laser radiation for reflecting the laser radiation;
a first lens or lens group arranged in the direction of the beam path;
a dichromatic mirror arranged in the direction of the beam path for coupling out part of the laser radiation;
a second lens disposed in the direction of the outcoupled portion of the optical path; and
a sensor arranged in the direction of the decoupled part of the beam path, on which the decoupled part of the laser radiation impinges.

2. The system of claim 1, wherein the laser radiation entry port is a laser light cable connected to a laser source.

3. The system of claim 1, wherein the first lens or lens group focuses the laser radiation.

4. The system of claim 1, wherein the second lens or lens group focuses the coupled-out portion of the laser radiation onto the sensor.

5. The system of claim 1, wherein the first and/or second lens or lens group is a tunable lens, or the lens group comprises at least one tunable lens, wherein the optical properties of a tunable lens are changeable by external excitation.

6. The system of claim 1, wherein the first lens or lens group is connected to a first displacement member and the second lens or lens group is connected to a second displacement member for displacing the respective lens or lens group on the beam axis

7. The system of claim 1, wherein the sensor is connected to a third displacement device for displacement thereof along the beam axis.

8. The system of claim 1, wherein an optical filter is disposed between the dichromatic mirror and the sensor.

9. The system of claim 1, wherein an aperture is disposed between the dichromatic mirror and the second lens.

10. The system of claim 9, wherein a hole of the aperture is offset from the beam axis of the laser radiation.

11. The system of claim 1, wherein a protective glass is disposed behind the tip of the optical fiber in the direction of the beam path of the laser radiation, and a third lens or lens group is disposed behind the protective glass.

12. The system of claim 1, wherein the third lens is a tunable lens or the lens group comprises at least one tunable lens.

13. The system of claim 1, wherein a beam shaping element is additionally arranged in the beam path.

14. The system of claim 1, wherein the first mirror is a tip-tilt mirror or deformable mirror.

15. A method for monitoring the condition of optical elements of a laser material processing device, comprising:
receiving with a sensor in the beam source direction of a laser beam source the outcoupled portion of a high-power laser beam or laser radiation, the outcoupled portion of the high power laser beam or laser radiation being outcoupled by a dichromatic mirror.

16. The method of claim 15, wherein the high-power laser beam or laser radiation is formed by a first lens or lens group in front of the dichromatic mirror, wherein the first lens is a tunable lens or the lens group comprises at least one tunable lens.

17. The method of claim 15, wherein the high-power laser beam or laser radiation is formed by a second lens or lens group between dichromatic mirror and sensor, wherein the second lens is a so-called tunable lens or the lens group comprises at least one tunable lens.

18. The method of claim 15, wherein the high power laser beam or laser radiation is deflected by a deflection mirror in front of the first lens or lens group toward the first lens or lens group.

19. The method of claim 15, wherein the high power laser beam or laser radiation passes through a filter upstream of the sensor.

20. The method of claim 15, wherein the high power laser beam or laser radiation passes through an aperture offset from the beam axis in front of the second lens or lens group.

21. The method of claim 14, comprising the step of determining at least one property selected from the group comprising the laser beam position in x, y direction, the laser beam diameter, the energy distribution in the laser beam, the center of the laser beam, and the wavefront of the laser beam.
